(19) United States
(12) Patent Application Publication
(10) Pub. No.: US 2024/0253330 A1
(43) Pub. Date: Aug. 1, 2024

(54) GLAZING FOR PREVENTING BIRD COLLISIONS

(71) Applicant: AGC GLASS EUROPE, Louvain-la-Neuve (BE)

(72) Inventor: Stijn MAHIEU, Lovendegem (BE)

(73) Assignee: AGC GLASS EUROPE, Louvain-la-Neuve (BE)

(21) Appl. No.: 18/578,210

(22) PCT Filed: Jul. 20, 2022
(86) PCT No.: PCT/EP2022/070340

§ 371 Date: Jan. 10, 2024

(30) Foreign Application Priority Data
Jul. 27, 2021 (EP) 21187909.3

(51) Int. Cl. B32B 17/10

(52) U.S. Cl. CPC B32B 17/10045; B32B 17/10119; B32B 17/10128; B32B 17/10183; B32B 17/10201; B32B 2255/20; B32B 2255/28; B32B 2307/414; B32B 2307/416; B32B 2307/7376

(57) ABSTRACT

A window for reducing or preventing bird collisions therewith. The window includes a first substrate and a second substrate, spaced apart from one another. The first substrate is configured to face an exterior of a building and has a first coating on an inward facing surface. The first coating reflects ultraviolet (UV) radiation, and includes first, second, and third layers in this order moving away from the first substrate. The first and third layers each contain at least one dielectric material chosen among niobium oxide, titanium oxide, zirconium oxide, a mixed oxide of titanium and zirconium, and a mixed nitride of zirconium and silicon, and the second layer contains silicon oxide SiOₓ. The first coating contains only the first, second and third layers.

### TECHNICAL FIELD

This invention relates to an insulating glass (IG) window unit designed to prevent or reduce bird collisions therewith. The IG unit includes at least first and second substrates, spaced apart from one another, wherein the first substrate is configured to face the exterior of a building, supports on its inwards facing surface a coating which reflects ultraviolet (UV) radiation from the sun so that birds are capable of more easily seeing the window. By making the window more visible to birds, bird collisions and bird deaths can be reduced. The first substrate may in particular be laminated to a third substrate via a polymer-based laminating film (e.g., of or including PVB, EVA, or SGP). The provision of the laminated substrates in the IG window unit is particularly advantageous for bird friendly windows, because it can further reduce bird collisions by providing increased contrast ratio, improve durability, and improve processing.

### BACKGROUND ART

Many buildings are provided with IG window units including glass substrates coated for example with a solar management coating (e.g., multi-layer coating for reflecting at least some infrared radiation) on an interior surface of one of the two substrates. Such IG units enable significant amounts of infrared (IR) radiation to be blocked so that it does not reach the interior of the building (apartment, house, office building, or the like).

Unfortunately, bird collisions with such windows represent a significant problem, in particular when those buildings are located in migratory bird paths. Birds flying along these paths repeatedly run into these buildings because they cannot see the windows of the building. This results in thousands of bird deaths, especially during seasons of bird migration. Birds living in environments such as forests or park areas, with buildings located in such areas, face similar problems associated with flying into the buildings.

Conventional ways of reducing bird collisions with windows include the use of nets, decals, or frit. However, these solutions are considered ineffective because of the aesthetic impact on the architecture and/or because they do not work as they do not make the glass more visible to birds.

Alternately, US2009130349A1, WO2015183681A1 and WO2019055953A1 for example disclose IG window units for reducing bird collisions, comprising a UV reflecting first coating on the outwards facing surface of the first, outermost, substrate so as to maximize the degree of UV reflectance. While the performance regarding collisions appears satisfactory, the coating nevertheless is subjected to wear and tear by its exposure to weather and cleaning. Furthermore, even if the coating is designed to be mostly visible in the ultraviolet wavelength range, the coating is still noticeable to the naked human eye, in particular when it is applied in a pattern.

Thus, there is room for improvement. In view of the above, it will be appreciated that there exists in particular a need in the art for improved windows which can prevent or reduce bird collisions therewith and which shows improved durability.

### SUMMARY OF INVENTION

The present invention concerns, in certain embodiments, a window designed to prevent or reduce bird collisions therewith. The window may be an insulating glazing window unit. The window comprises at least first and second substrates, spaced apart from one another, wherein the first substrate is configured to face the exterior of a building and supports on its inwards facing surface a first coating which reflects ultraviolet (UV) radiation from the sun so that birds are capable of more easily seeing the window. The UV reflecting first coating comprises at least first, second, and third layers in this order moving away from the glass substrate, and wherein the first and third layers comprise a dielectric material chosen among niobium oxide, titanium oxide, zirconium oxide, a mixed oxide of titanium and zirconium, or a mixed nitride of zirconium and silicon and the second layer comprises silicon oxide SiOx.

The inventors have found that such a window may prevent or reduce bird collisions therewith and that the UV reflecting first coating is protected from wear and tear and that it is less noticeable by the naked eye. In particular color changes upon changing viewing angles may be much less noticeable. In particular the use of materials such as niobium oxide, titanium oxide, zirconium oxide, mixed oxides of titanium and zirconium, mixed nitrides of zirconium and silicon, or silicon oxide SiOx enables the first coating to reach high UV light reflectance and low UV absorption

In an embodiment of the present invention the first substrate has an ultraviolet light transmittance (Tuv), measured according to standard EN410:2011 and in the uncoated state of the substrate of at least 70%, preferably of at least 80%, more preferably of at least 85%. This ultraviolet light transmittance level may be reached by adjusting the composition of the substrate as is well known in the art. Higher UV light transmittance leads to higher levels UV light reflected by the UV reflecting first coating to be visible by birds as less UV light is absorbed.

In an embodiment of the present invention the first layer may be from 3 to 30 nm thick, the second layer may be from 20 to 90 nm thick, and the third layer may be from 5 to 50 nm thick. Thicknesses within the present description are geometric, or physical thicknesses, not optical thicknesses, unless otherwise noted.

In an embodiment of the present invention the first substrate is a soda lime glass substrate comprising less than 0.04 percent by weight of iron oxide (expressed as Fe₂O₃), preferably less than 0.02 percent by weight and a redox ratio, measured as the ratio of iron in the ferrous state (expressed as FeO) to the total amount of iron (expressed as Fe₂O₃) of more than 0.4. In soda lime glass substrates, the iron oxide content was found to be responsible for a large part of the absorption of ultraviolet light.

In an embodiment of the present invention, in the UV reflecting first coating, the second layer comprises up to 20 at % of aluminium.

In an advantageous embodiment of the present invention, in the UV reflecting first coating, in addition to providing high UV light reflectance and low UV absorption when used in the UV reflecting first coating, like niobium oxide or zirconium oxide, the mixed oxides of titanium and zirconium and mixed nitrides of zirconium and silicon these materials, but not titanium oxide, may be submitted to heat treatment, such as tempering or bending, without being degraded, for example without increase of its haze level.

Advantageously, first and third layers according to the invention, for example comprising niobium oxide, titanium oxide, zirconium oxide, a mixed oxide of titanium and zirconium or a mixed nitride of zirconium and silicon, have an absorption coefficient k at a wavelength of 550 nm lower than 0.1, and a refractive index n at a wavelength of 550 nm comprised between 2.1 and 2.8. The first and third layers may have differing compositions or may consist of a single layer or of two or more layers of different composition chosen among the materials niobium oxide, titanium oxide, zirconium oxide, a mixed oxide of titanium and zirconium or a mixed nitride of zirconium and silicon. Niobium oxide, mixed oxide of titanium and zirconium, and mixed nitride of zirconium and silicon are generally preferred for their particular resistance to heat treatments. More preferably, the first and third layers each essentially consist(s) of Tiₓ₁Zr_{y1}O_{z1} or of Siₓ₂Zr_{y2}N_{z2}.

In a particular, the third layer may comprise zirconium oxide if it is the last layer in the layer tack, where it has less influence on the temperability and still provides high mechanical durability during processing.

Tiₓ₁Zr_{y1}O_{z1} (TZO) is a mixed oxide of titanium and zirconium, comprising at least 35% by weight of titanium oxide, preferably at least 40% by weight of titanium oxide, more preferably at least 50% of titanium oxide. The expression “layer essentially consisting of Tiₓ₁Zr_{y1}O_{z1}” is also understood to encompass layers doped with at least one other element and containing up to at most 10% by weight of this at least one other element, said doped layers having properties, in particular optical properties, that are practically no different from those of pure Tiₓ₁Zr_{y1}O_{z1} layers (for example, layers deposited by cathode sputtering processes using a TiZr target containing up to 10% by weight Al).

Siₓ₂Zr_{y2}N_{z2} (SZN), is a mixed nitride of silicon and zirconium, comprising an atomic ratio of Zr to the sum Si+Zr, y2/(x2+y2), which is between 10.0% and 40.0%, these values being incorporated, indeed even between 15.0% and 25.0%. The expression “layer essentially consisting of Siₓ₂Zr_{y2}N_{z2}” is also understood to encompass layers doped with at least one other element and containing up to at most 10% by weight of this at least one other element, said doped layers having properties, in particular optical properties, that are practically no different from those of pure Siₓ₂Zr_{y2}N_{z2} layers (for example, layers deposited by cathode sputtering processes using a SiZr target containing up to 10% by weight Al).

Advantageously, the second layer, comprising SiOx, has an absorption coefficient k at a wavelength of 550 nm lower than 0.1, and a refractive index n at a wavelength of 550 nm lower than 1.9, preferably lower than 1.8, more preferably comprised between 1.4 and 1.8. Oxides of silicon are preferred for their particular resistance to heat treatments. More preferably, the second layer essentially consists of silicon oxide (SiOx, with x comprised between 1.6 and 2.1), still more preferably the second layer essentially consists of SiO₂. The expression “layer essentially consisting of oxides of silicon” is also understood to encompass layers doped with at least one other element and containing up to at most 20% by weight of this at least one other element, said doped layers having dielectric properties that are practically no different from those of pure silicon oxide layers (for example, layers deposited by cathode sputtering processes using a SiAl target containing up to 20% by weight Al, for example 10% Al).

In certain less preferred embodiments, the second layer comprising SiOx comprises nitrogen at a N/O atomic ratio less than 10% nitrogen, more advantageously less than 5%, even more advantageously less than 1%. Indeed, the presence of nitrogen tends to increase the refractive index of the second layer and reduce the UV reflecting first coating's performances.

The inventors have found that a IG window unit of the present invention,
a. reflects at least 20% of UV radiation in at least a substantial part of the range from 315 nm to 390 nm and
b. maintains this level of UV reflection, because it is not exposed to wear and tear of exposure,
c. shows reduced visibility to the naked human eye compared to the same IG window unit but with the UV reflecting first coating located on the outermost glass substrate.

In certain advantageous embodiments of the present invention, the UV reflecting first coating is not part of a low emissivity (lowE) coating, in particular no transparent conductive oxide based lowE coating, and does not contain any IR reflecting layer of silver or gold.

In certain advantageous embodiments of the present invention, the UV reflecting first coating does not coating does not contain any UV absorbing layer.

In certain example embodiments, a functional coating, such as a low emissivity, insulating or solar control coating, is provided on at least one face of the second substrate.

n certain advantageous embodiments of the present invention, the UV reflecting first coating is patterned so that the UV reflecting first coating is not provided continuously across the entire first substrate.

The following information is used in the present invention:
a. light transmission (LT) is the percentage of incident light flux, illuminant D65/2°, transmitted by the glazing;
b. light reflection (LR) is the percentage of incident light flux, illuminant D65/2°, reflected by the glazing. It may be measured on the external side of the building or vehicle (LRext) or the internal side of the building or vehicle (LRint);
c. energy transmission (ET) is the percentage of incident energy radiation transmitted by the glazing calculated in accordance with standard EN410:2011;
d. energy reflection (ER) is the percentage of incident energy radiation reflected by the glazing calculated in accordance with standard EN410:2011. It may be measured on the external side of the building or vehicle (ERext) or the internal side of the building or vehicle (ERint);
e. solar factor (SF or g) is the percentage of incident energy radiation that is directly transmitted by the glazing, on the one hand, and absorbed by this, then radiated in the opposite direction to the energy source in relation to the glazing. It is here calculated in accordance with standard EN410:2011;
f. the U value (coefficient k) and emissivity (E) are calculated in accordance with standards EN673:2011 and ISO 10292:1994;
g. the CIELAB 1976 values (L*a*b*) are used to define the tints of reflected and transmitted light. They are measured with illuminant D65/10°;
h. ΔE*=\sqrt{(ΔL*)²+(Δa*)²+(Δb*)²} represents the tint variation, i.e. variations of transmitted or reflected colors, due to the heat treatment, i.e. the color difference before and after heat treatment;
i. The haze level is measured on single glass sheets according to standard D1003-95, using a white light source, for example using a BYK-Gardner Haze-gard measurement apparatus;
j. the resistance per square (R2) (“sheet resistance”), expressed in ohms per square (Ω/□), measures the electrical resistance of thin films;
k. When values are referred to as “in the range of between a and b” or “from a to b”, they may be equal to a or b.

The positioning of coatings in a multiple glazing unit may be given according to the usual sequential numbering of the faces of a glazing unit, face 1 being on the exterior of the building or vehicle and face 4 (in the case of a glazing unit comprising two substrates) or face 6 (in the case of a glazing unit comprising three glass substrates) on the interior.

For the sake of clarity, when using terms like “below”, “above”, “lower”, “upper”, “first” or “last” herein, it is always in the context of a sequence of layers in a coating starting from the glass substrate below, going upward, further away from the glass. Such sequences may comprise additional intermediate layers, in between the defined layers, except when a direct contact is specified. Terms like “outwards”, “inwards”, “outermost”, “innermost” designate an orientation or location in an insulating glazing window unit as it would be when installed in a building,

### BRIEF DESCRIPTION OF DRAWINGS

These and further aspects of the invention will be explained in greater detail by way of example and with reference to the accompanying drawings in which:

FIGS. 1, 2, 3, and 4 are a cross sectional, schematic views of insulating glazing window units according to certain example embodiment of this invention.

FIG. 5 is cross sectional view of a UV reflecting first coating on a glass substrate, which may be used in the IGU of FIGS. 1 to 4 according to example embodiments of this invention.

FIG. 6 is cross sectional view of another UV reflecting first coating on a glass substrate, which may be used in the IGU of FIGS. 1 to 4 according to example embodiments of this invention.

FIG. 7 is cross sectional view of another UV reflecting first coating on a glass substrate, which may be used in the IGU of FIGS. 1 to 4 according to example embodiments of this invention.

The Figures are not drawn to scale.

### DESCRIPTION OF EMBODIMENTS

In certain embodiments, the IG window unit includes a third substrate spaced apart from and in between the first and second glass substrates, the first and third glass substrates being laminated to one another via a polymer-based laminating film, for example including polyvinyl butyrate (PVB), ethylvinyl acetate (EVA) or an ionoplast polymer such as for example Sentryglas™ from Kuraray.

In certain embodiments of the present invention, the third substrate, if present, is provided on its inwards facing side with a low emissivity coating, such as an insulating coating or a solar control coating.

In certain embodiments of the present invention, in the UV reflecting first coating, the first layer is in direct contact with the substrate and with the second layer and the third layer is in direct contact with the second layer. In certain particular embodiments, the UV reflecting first coating may comprise no other layer than the first, second and third layers, that is it consists of the first, second and third layers. It was found that this represents the most economical, UV reflecting first coating, that still showed acceptable UV reflecting performance.

In certain embodiments the UV reflecting first coating in the IG window unit of the present invention may comprise a fourth layer above the third layer, moving away from the glass substrate, wherein the fourth layer advantageously has an absorption coefficient k at a wavelength of 550 nm lower than 0.1, and a refractive index n at a wavelength of 550 nm lower than 1.9, preferably lower than 1.8, more preferably comprised between 1.4 and 1.8 and for example comprises silicon oxide SiOx. The resulting coated glass sheet was found to reflect at least 20% of UV radiation in at least a substantial part of the range from 315 nm to 390 nm and maintains this level of UV reflection after heat treatment. Furthermore the variations due to heat treatment in transmitted and reflected colors are very low. Advantageously, the first layer is in direct contact with the substrate and with the second layer and the third layer is in direct contact with the second layer and the fourth layer. The fourth layer may in certain embodiments described further below be in contact with

In certain embodiments the UV reflecting first coating in the IG window unit of the present invention may comprise a fourth above the third layer and a fifth layer above the fourth layer, moving away from the glass substrate, wherein the fourth layer advantageously has an absorption coefficient k at a wavelength of 550 nm lower than 0.1, and a refractive index n at a wavelength of 550 nm lower than 1.9, preferably lower than 1.8, more preferably comprised between 1.4 and 1.8 and for example comprises silicon oxide SiOₓ and wherein the fifth layer has an absorption coefficient k at a wavelength of 550 nm lower than 0.1, and a refractive index n at a wavelength of 550 nm comprised between 2.1 and 2.8 an for example comprises a dielectric material chosen among niobium oxide, titanium oxide, zirconium oxide, a mixed oxide of titanium and zirconium, or a mixed nitride of zirconium and silicon. Alternately, fifth layer may comprise niobium oxide and/or zirconium oxide. In particular, the fifth layer may comprise zirconium oxide if it is the last layer in the layer stack. The resulting coated glass sheet was found to reflect at least 40% of UV radiation in at least a substantial part of the range from 315 nm to 390 nm and maintains this level of UV reflection after heat treatment. Furthermore the variations due to heat treatment in transmitted and reflected colors are very low when a mixed oxide of titanium and zirconium, or a mixed nitride of zirconium and silicon and SiOx are used respectively for the fifth and fourth layers. Advantageously, the first layer is in direct contact with the substrate and with the second layer and the third layer is in direct contact with the second layer and the fourth layer and the fifth layer is in direct contact with the fourth layer.

In a particular, the fifth layer may comprise zirconium oxide if it is the last layer in the layer tack, where it has less influence on the temperability and still provides high mechanical durability during processing.

In certain embodiments the glass substrate coated with the UV reflecting first coating may have no haze noticeable by the human eye, even after optional heat treatment (tempering, bending), that is, as measured, a haze level after optional heat treatment of not more than 0.04%. This low haze, at least before heat treatment, may be obtained for example by depositing at least the first, third and fifth layers by magnetron sputtering. Coatings deposited by atmospheric pressure chemical vapor deposition on hot glass generally leads to higher roughness values and higher haze levels,

In certain embodiments, of the present invention the third, or the fourth, or the fifth layer may be the outermost layer of the coated glass sheet.

In certain example embodiments, there is provided a spacer or peripheral seal (10) is provided around the edge of the second substrate and the third substrate, if present, or around the edge of the second and the first substrate. The space between the second substrate and the third substrate, if present, or else the first substrate, may be evacuated to a pressure lower than atmospheric, forming a vacuum insulating glazing (VIG), and/or may be filled with a gas (e.g. Ar). An array of spacers (not shown) may be provided between the substrates in a viewing area of the window for spacing the substrates from one another as in the context of a VIG. The spacer(s) (10), other spacer(s), and/or peripheral seal space the two substrates (11 and 12) apart from one another so that the substrates do not contact one another and so that a space or gap (14) is defined therebetween. Alternatively, space (14) between the substrates (11, 12) need not be filled with a gas and/or need not be evacuated to a low pressure. In certain example embodiments, it is possible to suspend foil or other radiation reflective sheet(s) (not shown) in space (14). When substrate(s) (11 and/or 12) are of glass, each glass substrate may be of the soda-lime-silica type of glass, or any other suitable type of glass, and may be for example from 1 to 10 mm thick in certain example embodiments of this invention.

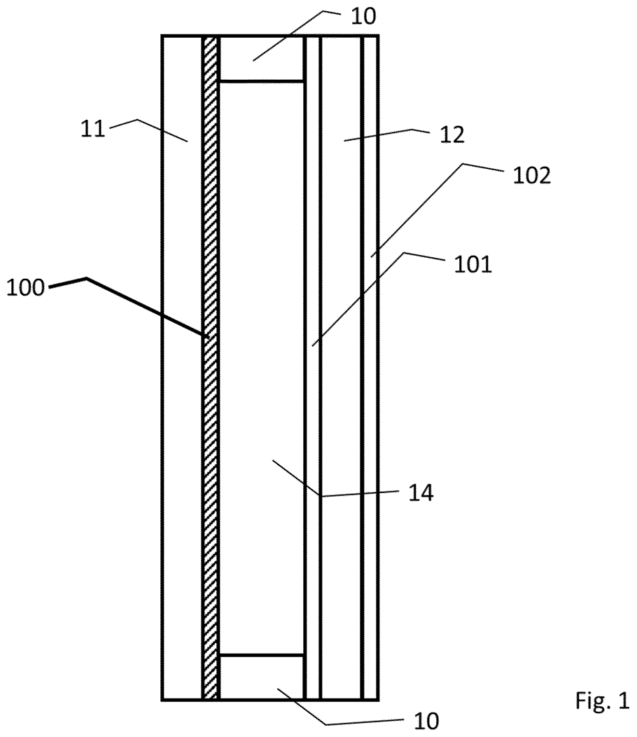

The IGU of FIG. 1 may optionally include a first functional coating (101) (e.g., a solar control or a an insulating low-emissivity coating) that is supported in this example on the outwards facing surface of the second substrate (12).

Still referring to FIG. 1 the IGU optionally comprises second functional coating (102) that is supported in this example on the inwards facing surface of the second substrate (12). Second functional coating (102) advantageously comprises at least one layer of a transparent conductive oxide (TCO), for example comprising indium doped tin oxide, fluorine or antimony doped tin oxide, aluminum doped zinc oxide. Second functional coating (102) may further comprise below the TCO an undercoat of one or two layers, so as to neutralize colors in reflection. Second functional coating (102) may further comprise a topcoat over the TCO, so as to avoid condensation droplets (e.g. a layer of TiO2) or so as to lower reflectance (e.g. a layer of SiO2).

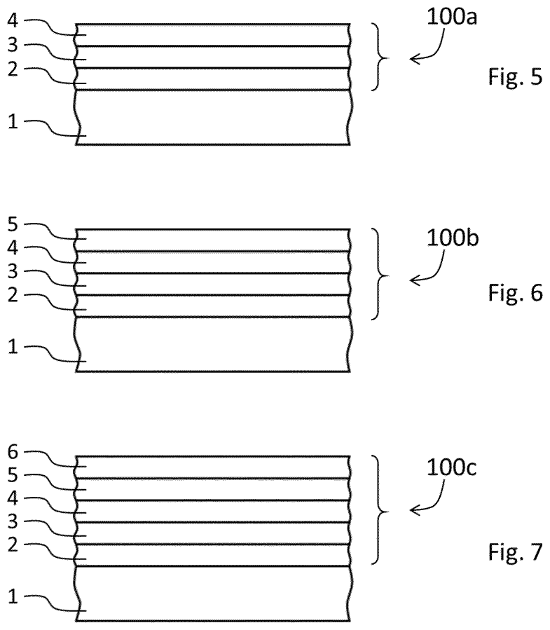

Still referring to FIG. 1, the IGU further includes UV reflecting first coating (100) for reflecting significant amounts of UV radiation thereby making the window more visible to birds. Coatings (100) may be sputter-deposited in example embodiments of this invention. UV reflecting first coating (100) may be, for purposes of example and without limitation, any of the UV reflecting first coatings illustrated in FIGS. 5-7. This increases the UV reflection of the window unit in order to make such windows more visible to birds thereby preventing or reducing bird collisions. The use of such coatings (100) herein enhances the performance of the glass or window by increasing the UV reflectance beyond the normal limits of raw uncoated plate glass in the 315 nm to 390 nm range of the spectrum. In certain embodiments, the UV reflecting first coating (100) is in direct contact with the glass substrate (11) on the interior surface thereof, and is not part of a low emissivity or solar control coating. In particular, there are no IR reflecting layers (e.g., silver based, gold based, NiCr, or IR reflecting TCO-based layers) in coating (100), and there are no IR reflecting layers on the outside of the substrate (11) on which the coating (100) is provided.

In certain example embodiments, the first substrate (11) with UV reflecting first coating (100) may block the transmission of at least 25% (more preferably at least 40%, more preferably at least 55%, even more preferably at least 60%, and possibly at least 65%) of UV radiation in at least a substantial part of the range from 315 nm to 390 nm.

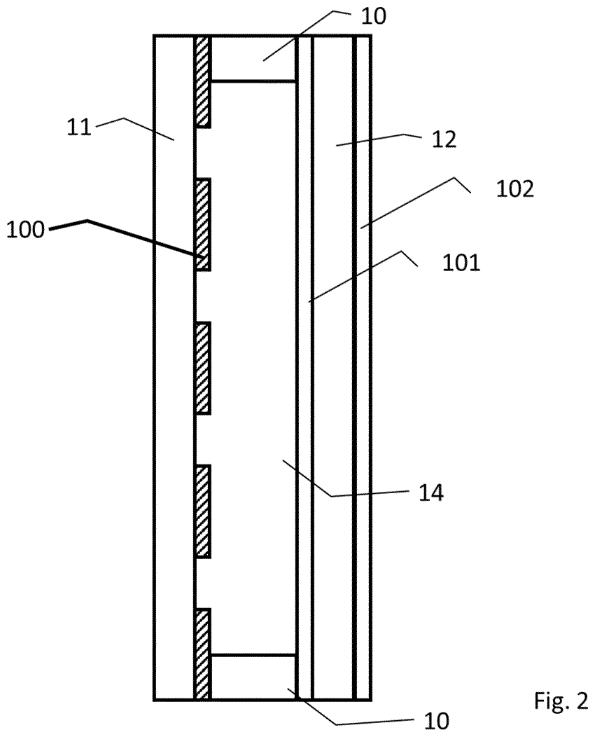

The UV reflecting first coating (100) may be patterned (e.g., in the shape of a grid or in substantially parallel or non-parallel stripes) on the surface of substrate (1) as shown in FIG. 2, or alternatively may be provided continuously across substantially the entire surface of substrate (1) in other embodiments. The patterned shape of coating (100) may be formed as follows. A pattern (not shown) is provided on the surface of substrate (11) prior to the coating (100) being formed, with the pattern being located in areas which are ultimately to be free of coating (100). After the pattern is formed, a coating (100) is continuously formed across the entire or substantially the entire surface of substrate (11) over the pattern. The pattern can then be removed (along with the portions of coating (100) located directly over it) in order to create a patterned coating (150), so that the coating (100) remains on only the portions of the substrate where the original pattern was not deposited. Thus, a patterned coating (100) can be formed in such a manner in example embodiments of this invention. The remaining patterned coating (100) is substantially invisible to human eyes, but is visible to bird eyes as explained above. The pattern may also be formed by using masks positioned in between the sputtering targets used for the deposition of the UV reflecting first coating, at least for first, third and fifth layers of this coating, and the glass substrate. A pattern may also be formed by coating the whole substrate first and by partially removing the coating afterwards, for instance by laser ablation of the coating.

According to an embodiment of the present invention, the pattern may be such that each area coated with the complete first coating, has a surface area of 250 to 1500 mm². Such area sizes may make the coated areas more recognizable for birds. For the avoidance of doubt, in patterned first coatings herewithin, areas coated with the complete first coating are continuous, or uninterrupted areas, that are surrounded by non-coated areas, unless where they reach the edges of the substrates.

According to an embodiment of the present invention, the pattern may be such that every area coated with the complete first coating, is distanced from the closest neighbouring area coated with the complete first coating by at least 30 mm, advantageously by at least 50 mm. In certain embodiments every area coated with the complete first coating, is distanced from the closest neighbouring area coated with the complete first coating by at up 150 mm, advantageously up to 120 mm, more advantageously up to 100 mm. Such distances may make the distinction between coated and non-coated area more distinguishable to birds.

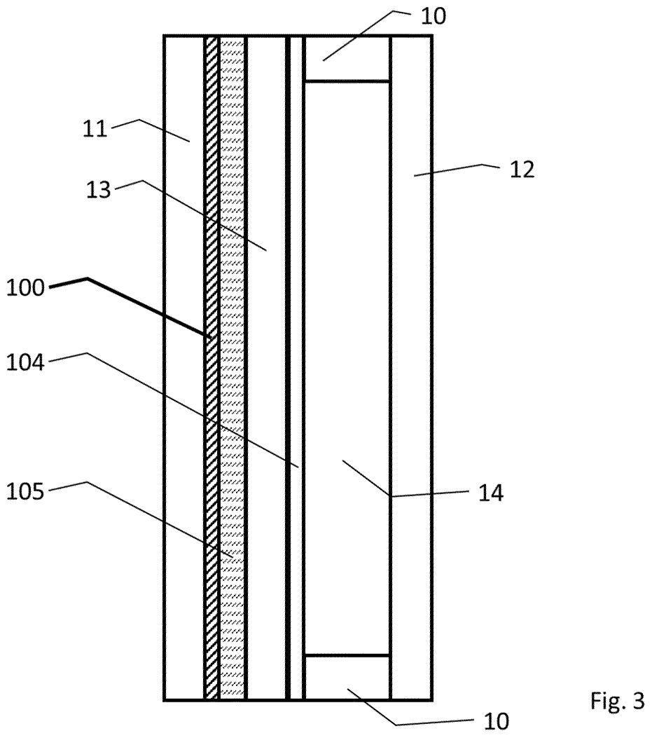

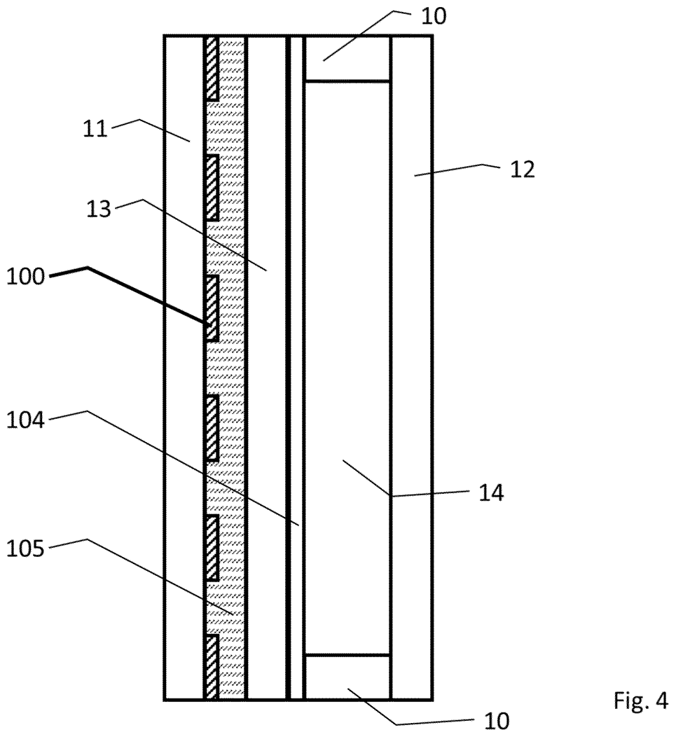

The IG window unit may comprise, as shown in FIGS. 3 and 4, a third substrate (13) laminated to the first substrate (11) via a thermoplastic interlayer (105). The thermoplastic interlayer contacts the outermost layer of the UV reflecting first coating (100). When the UV reflecting first coating (100) is patterned and a third substrate is laminated to the first substrate (11), as shown in FIG. 4, the thermoplastic interlayer (105) may contact both the first substrate surface and the outermost layer of the UV reflecting first coating (100). Lamination results in completely blocking UV transmission through the glazing.

As shown in FIGS. 3 and 4, when a third substrate is laminated to the first substrate, a third functional coating (104) (e.g., a solar control or a an insulating low-emissivity coating) that is supported on the inwards facing surface of the third substrate (13), that is, on the surface of the third substrate facing the second substrate.

Functional coatings (101, 104) may comprise a transparent conductive oxide or comprise at least one functional, infrared reflecting, layer comprising silver, and include one or more layers, and in many embodiments it may be multilayer coating. Low-emissivity functional coatings (101, 104) for example includes at least one infrared (IR) reflecting layer (e.g., based on silver) sandwiched between at least first and second dielectric layers. Since one example function of low-emissivity coatings (101, 104) is to block (i.e., reflect and/or absorb) certain amounts of IR radiation and prevent the same from reaching the building interior, the solar management coatings (101, 104) may include at least one IR blocking (i.e., IR reflecting and/or absorbing) layer. Example IR blocking layer(s) which may be present in coatings (101, 104) are of or include silver (Ag), nickel-chrome (NiCr), gold (Au), and/or any other suitable material that blocks significant amounts of IR radiation. It will be appreciated by those skilled in the art that IR blocking layer(s) of low-E coating (101, 104) need not block all IR radiation, but only need to block significant amounts thereof. In certain embodiments, each IR blocking layer of coating (101, 104) is provided between at least a pair of dielectric layers. Example dielectric layers include silicon nitride, titanium oxide, silicon oxynitride, tin oxide, zinc stannate, and/or other types of metal-oxides and/or metal-nitrides. In certain embodiments, in addition to being between a pair of dielectric layers, each IR blocking layer may also be provided between a pair of contact layers of or including a material such as an oxide and/or nitride of nickel-chrome or any other suitable material. Example low-emissivity coatings (101, 104) which may be provided on substrates (12, 13) are described in Patents WO03106363A1, WO2004071984A1, WO2006048462A1, WO2009115595A1, WO2009115596A1, WO2009115599A1, WO2006048463A1, WO2006067102A1, WO2006122900A1, WO2007138097A1, WO2008113786A1, WO2011147875A1, WO2011147864A1, WO2013079400A1, WO2014191472A1, WO2014191474A1, WO2014191484A1, WO2014125081A1, WO2014125083A1, WO2014207171A1, all of which are hereby incorporated herein by reference. Of course, solar management coatings (101, 104) herein are not limited to these particular coatings, and any other suitable solar management coatings capable of blocking amounts of IR radiation may instead be used. Solar management coatings (101, 104) herein may be deposited on substrate(s) (12) and/or (13) in any suitable manner, including but not limited to sputtering, vapor deposition, and/or any other suitable technique.

In a particular embodiment the first layer, the third layer, and the fifth layer, if present, are identically patterned so that the first layer, the third layer, and the fifth layer are not provided continuously across the entire coated glass sheet and so that the second layer and the fourth layer, if present, are provided over the entire coated glass sheet. Such a coating is easier to deposit if masks are used during deposition by sputtering. Furthermore, the second and fourth layers provide additional protection to the glass surface against chemical aggression.

It is indeed a particular advantage of the UV reflecting first coatings of the present invention they are substantially invisible to human eyes. This means that the color of the reflected light of a substrate with this is very close to the color of the reflected light of the substrate without this coating. The color coordinates a* and b* of the reflected light of the substrate with this coating, a*(coated) and b*(coated), are such that they are very close to the color coordinates of the reflected light of the substrate without this coating, a*(uncoated) and b*(uncoated). In particular a*(coated) and b*(coated) may be such that a*(uncoated)−1<a*(coated)<a*(uncoated)+1 and b*(uncoated)−1<b*(coated)<b*(uncoated)+1.5. The substrate may bear a coating on the opposite side to the UV reflecting first coating and/or be part of a multiple glazing, in which cases the same applies.

As shown in FIG. 1, IG units which have two glass substrates (11) and (12) typically are characterized as having four surfaces. In particular, surface #1 faces the building exterior, surface #2 is the interior coated surface of the same substrate (11) but faces the interior space/gap (14) of the IG unit, surface #3 is the interior coated/uncoated surface of the other substrate (12) facing the interior space/gap (14), and surface #4, coated/uncoated, faces the building interior. In the FIG. 1 embodiment, UV reflecting first coating (100) is provided on surface #2 and the first functional coating (101) is provided on surface #3. In certain example embodiments, before and/or after optional heat treatment (e.g., thermal tempering and/or heat bending), the coating (101) in the FIG. 1 embodiment may have a sheet resistance (Rs) of no greater than 8 ohms/square, more preferably no greater than 6 ohms/square, and most preferably no greater than 4 ohms/square. In certain embodiments, the coating (101) may have an emissivity (En) after heat treatment of no greater than 0.10, more preferably no greater than 0.07, and even more preferably no greater than 0.05 (before and/or after optional heat treatment).

In certain example embodiments, similar to embodiments illustrated by FIGS. 1 and 2, the insulation of the IG window unit of FIG. 3 or 4 may be further improved by providing an low emissivity coating (not shown) on surface #6, that is, the surface of the innermost glass substrate (12) that faces the inside of the building. Second functional coating (102) advantageously comprises at least one layer of a transparent conductive oxide (TCO), for example comprising indium doped tin oxide, fluorine or antimony doped tin oxide, aluminum doped zinc oxide. Second functional coating (102) may further comprise below the TCO an undercoat of one or two layers, so as to neutralize colors in reflection. Second functional coating (102) may further comprise a topcoat over the TCO, so as to avoid condensation (e.g. a layer of TiO2) or so as to lower reflectance (e.g. a layer of SiO2).

FIGS. 5-7 are cross sectional views UV reflecting first coating (100) according to certain embodiments (100a, 100b, 100c) that may be used on substrate (11) in the IGUs of FIGS. 1, 2, 3 and 4, in example embodiments of this invention. Glass substrate (11) may be soda-lime-silica based glass or any other suitable type of glass, and may be from 1-12 mm thick, more preferably from 2-6 mm thick, in example embodiments of this invention.

In the embodiments illustrated by FIG. 5, first coating (100a) includes, in sequence starting from the glass substrate (11), first and third layers (2,4) that comprise a dielectric material chosen among an oxide of titanium, an oxide of niobium, a mixed oxide of titanium and zirconium, or a mixed nitride of zirconium and silicon and a second layer (3) comprising SiOx or an oxynitride of silicon.

In certain example embodiments of this invention illustrated by FIG. 5,
a. the first layer (2) may be from 3 to 20 nm thick, preferably from 6 to 16 nm thick, more preferably from 8 to 14 nm, and
b. the second layer (3) may be from 20 to 60 nm thick, more preferably from 30 to 50 nm thick, even more preferably from 35 to 45 nm thick, and
c. the third layer (4) may be from 20 to 50 nm thick, more preferably from 25 to 45 nm thick, even more preferably from 30 to 40 nm thick.

In the embodiments illustrated by FIG. 6, first coating (100b) includes, in sequence starting from the glass substrate (1), first and third layers (2,4) that comprise a dielectric material chosen among an oxide of titanium, an oxide of niobium, a mixed oxide of titanium and zirconium, or a mixed nitride of zirconium and silicon and second and fourth layers (3,5) comprising SiOx.

In certain example embodiments of this invention illustrated by FIG. 6,
a. the first layer (2) may be from 3 to 20 nm thick, preferably from 6 to 16 nm thick, more preferably from 4 to 7 nm thick, even more preferably from 8 to 14 nm, and
b. the second layer (3) may be from 20 to 60 nm thick, more preferably from 30 to 50 nm thick, even more preferably from 35 to 45 nm thick, and
c. the third layer (4) may be from 20 to 50 nm thick, more preferably from 25 to 45 nm thick, even more preferably from 30 to 40 nm thick.
d. the fourth layer (5) may be from 3 to 110 nm thick.

In the embodiments illustrated by FIG. 7, first coating (100c) includes, in sequence starting from the glass substrate (1), first and third layers (2,4) that comprise a dielectric material chosen among a mixed oxide of titanium and zirconium, or a mixed nitride of zirconium and silicon, fifth layer (6) that may comprise an oxide of titanium, or a mixed oxide of titanium and zirconium, or a mixed nitride of zirconium and silicon and second and fourth layers (3,5) comprising SiOx.

In certain example embodiments of this invention illustrated by FIG. 7,
a. the first layer (2) may be from 3 to 30 nm thick, more preferably from 5 to 15 nm thick, even more preferably from 8 to 12 nm thick, with an example thickness being from 9 to 11 nm and
b. the second layer (3) may be from 40 to 90 nm thick, more preferably from 55 to 80 nm thick, even more preferably from 60 to 75 nm thick, with an example thickness being from 65 to 68 nm and
c. the third layer (4) may be from 5 to 50 nm thick, more preferably from 8 to 45 nm thick, nm thick, even more preferably from 12 to 25, with an example thickness being from 15 to 18 nm and
d. the fourth layer (5) may be from 20 to 80 nm thick, more preferably from 30 to 75 nm thick, even more preferably from 35 to 70 nm thick, even more preferably from 40 to 60 nm thick with an example thickness being from 58 to 63 nm and
e. the fifth layer (6) may be from 10 to 50 nm thick, more preferably from 15 to 45 nm thick, even more preferably from 20 to 40 nm thick, with an example thickness being from 31 to 35 nm.

The layers (2-6) of the UV reflecting first coating (100a,b,c) are preferably deposited by sputtering in example embodiments of this invention. For example, layers comprising an oxide of titanium (6) or layers comprising a mixed oxide of titanium and zirconium, or a mixed nitride of zirconium and silicon (2,4,6) may be sputter deposited via at least one metallic target of titanium, titanium-zirconium alloy or zirconium-silicon alloy respectively, via sputtering in an atmosphere including a mixture of argon and reactive oxygen gases or of argon and reactive nitrogen respectively. And for example, layers comprising silicon oxide SiOx (3,5) may be sputter deposited via at least one sputtering target of or including Si or SiAl, via sputtering in an atmosphere including a mixture of argon and reactive oxygen gases. Rotating C-Mag sputtering targets, or other types of targets, may be used. In sputtering operations, sufficient reactive oxygen or nitrogen gas may be used to achieve the refractive index values discussed herein. Ceramic targets may alternatively be used to sputter deposit one or more of these layers. While the layers of the UV reflecting first coating (100a,b,c) are preferably deposited via sputtering, it is possible that they may be deposited via other techniques in alternative embodiments of this invention. In particular layers comprising SiOx (3,5) may be deposited by plasma enhanced chemical vapor deposition (PECVD), in particular hollow cathode PECVD.

The present invention further concerns an insulated glazing unit (IGU) comprising a coated glass substrate according to any one of the embodiments of this invention described above.

In example embodiments of this invention, there is provided an IGU comprising:
a. a first glass substrate;
b. a second glass substrate spaced apart from the first glass substrate;
c. a UV reflecting first coating provided on a second side the first glass substrate configured to face an exterior of a building in which the IGU is to be mounted;
d. optionally, a functional, low-emissivity or solar control, coating provided on the outwards facing side of the second substrate;
e. wherein the UV reflecting first coating advantageously is not part of any low-emissivity coating and does not contain any infrared (IR) reflecting layer of silver or gold;
f. wherein the UV reflecting first coating is optionally patterned so that the UV reflecting first coating is not provided continuously across the entire first substrate;
g. wherein the UV reflecting first coating comprises first and third layers that comprise a dielectric material chosen among niobium oxide, titanium oxide, zirconium oxide, a mixed oxide of titanium and zirconium, or a mixed nitride of zirconium and silicon and a second layer comprising SiOx;
h. and wherein the IGU has a visible transmission of at least 20%, and the UV reflecting first coating reflects at least 20% of UV radiation in at the whole range from 315 nm to 390 nm;
i. and wherein the first glass substrate coated with the UV reflecting first coating and with the low-emissivity coating has a haze level after optional heat treatment of not more than 0.1%.

In the IGU of the immediately preceding paragraph, the UV reflecting first coating may reflect at least 20% of UV radiation in the whole range from 315 nm to 390 nm and may reflect on average 25% in the range from 315 nm to 390 nm. Additionally, the IGU of the immediately preceding paragraph, the UV reflecting first coating may reduce the transmittance of UV radiation by at least 15% in the whole range from 315 to 390 nm and may reduce the average transmittance of UV radiation by at least 20% in the range from 315 nm to 390 nm.

In a window of the present invention, in particular in the IGU of any of the preceding two paragraphs, the UV reflecting first coating may reflect at least 20% of UV radiation in the whole range from 315 nm to 390 nm and may reflect on average 25% in the range from 315 nm to 390 nm. Additionally, the IGU of the immediately preceding paragraph, the UV reflecting first coating may reduce the transmittance of UV radiation the whole range from 315 nm to 390 nm by at least 15% and may reduce the average transmittance of UV radiation by at least 40% in the range from 315 nm to 390 nm. This is in particular achieved when the UV reflecting first coating includes, in sequence starting from the glass substrate, first and third layers that comprise a dielectric material chosen among a mixed oxide of titanium and zirconium, or a mixed nitride of zirconium and silicon and second and fourth layers comprising SiOx.

In the IGU of any of the preceding three paragraphs, the UV reflecting first coating may reflect at least 25% of UV radiation in the whole range from 315 nm to 390 nm and may reflect on average 40% in the range from 315 nm to 390 nm. Additionally, the IGU of the immediately preceding paragraph, the UV reflecting first coating may reduce the transmittance of UV radiation in the whole range from 315 nm to 390 nm by at least 25% and may reduce the average transmittance of UV radiation by at least 50% in the range from 315 nm to 390 nm. This performance is in particular achieved when the UV reflecting first coating includes, in sequence starting from the glass substrate, first and third layers that comprise a dielectric material chosen among a mixed oxide of titanium and zirconium, or a mixed nitride of zirconium and silicon, fifth layer that may comprise an oxide of titanium, or a mixed oxide of titanium and zirconium, or a mixed nitride of zirconium and silicon and second and fourth layers comprising SiOx.

In the IGU of any of the preceding four paragraphs, the low-E coating may comprise first and second IR blocking layers each comprising Ag, at least one dielectric layer provided between the first IR blocking layer and the first substrate, at least another dielectric layer provided between the first and second IR blocking layers, and wherein the low-E coating supported by the first substrate has an emissivity (En) of no greater than 0.10 and/or a sheet resistance (Rs) of no greater than 8 ohms/square.

In the IGU of any of the preceding five paragraphs, the first and second glass substrates may be spaced apart from one another by at least one spacer and/or edge seal so as to define a space between the substrates. The space between the substrates may be filled with a gas and/or is evacuated to a pressure less than atmospheric.

In the IGU of any of the preceding six paragraphs, the first glass substrate coated with the UV reflecting first coating and with the low-emissivity coating may have no measurable haze level after optional heat treatment, that is, as measured, a haze level after optional heat treatment of not more than 0.04%.

The invention is not limited to the substrate being a glazing in a building. For example, the substrate may be a door, a balcony, a spandrel, or a part of any of these.

The present invention in certain embodiments concerns the following items:
Item 1. A window designed for reducing or preventing bird collisions therewith, the window comprising
   a. at least first (11) and second substrates (12), spaced apart from one another,
   b. wherein the first substrate (11) is configured to face the exterior of a building and
   c. supports on its inwards facing surface a first coating (100),
   d. the first coating (100) reflecting ultraviolet (UV) radiation and
   e. comprising at least first (2), second (3), and third (4) layers in this order moving away from the first glass substrate,
      i. wherein the first (2) and third (4) layers each comprise at least one dielectric material chosen among niobium oxide, titanium oxide, zirconium oxide, a mixed oxide of titanium and zirconium, or a mixed nitride of zirconium and silicon and the second layer (3) comprises silicon oxide SiOx.
Item 2. Window according to item 1, wherein the first coating further comprises after the third layer moving away from the glass substrate a fourth layer (5) and wherein the fourth layer (5) comprises silicon oxide SiOx.
Item 3. Window according to item 2, wherein the first coating further comprises after the fourth layer moving away from the glass substrate a fifth layer and wherein the fifth layer comprises at least one material chosen from niobium oxide, titanium oxide, zirconium oxide, a dielectric material chosen among titanium oxide, a mixed oxide of titanium and zirconium, or a mixed nitride of zirconium and silicon.
Item 4. Window according to item 1, wherein the first coating comprises only the first, second and third layers.
Item 5. Window according to item 1 or 4, wherein, in the first coating,
   a. the first layer (2) is from 3 to 20 nm thick, more preferably from 6 to 16 nm thick, even more preferably from 8 to 14 nm thick and
   b. the second layer (3) is from 20 to 60 nm thick, more preferably from 30 to 50 nm thick, even more preferably from 34 to 45 nm thick and
   c. the third layer (4) is from 20 to 50 nm thick, more preferably from 25 to 45 nm thick, even more preferably from 30 to 40 nm thick.
Item 6. Window according to item 2, wherein the first coating comprises only the first, second, third, and fourth layers.
Item 7. Window according to item 2 or 6, wherein, in the first coating,
   a. the first layer (2) is from 3 to 20 nm thick, more preferably from 6 to 16 nm thick, even more preferably from 8 to 14 nm thick and
   b. the second layer (3) is from 20 to 60 nm thick, more preferably from 30 to 50 nm thick, even more preferably from 34 to 45 nm thick and
   c. the third layer (4) is from 20 to 50 nm thick, more preferably from 25 to 45 nm thick, even more preferably from 30 to 40 nm thick.
   d. the fourth layer (5) is from 3 to 110 nm thick.
Item 8. Window according to item 4, wherein the first coating comprises only the first, second, third, fourth and fifth layers.
Item 9. Window according to item 4 or 9, wherein, in the first coating,
   a. the first layer (2) is from 3 to 30 nm thick, more preferably from 5 to 15 nm thick, even more preferably from 8 to 12 nm thick, with an example thickness being from 9 to 11 nm and
   b. the second layer (3) is from 40 to 90 nm thick, more preferably from 55 to 80 nm thick, even more preferably from 60 to 75 nm thick, with an example thickness being from 65 to 68 nm and
   c. the third layer (4) is from 5 to 50 nm thick, more preferably from 8 to 45 nm thick, nm thick, even more preferably from 12 to 25, with an example thickness being from 15 to 18 nm and
   d. the fourth layer (5) is from 20 to 80 nm thick, more preferably from 30 to 75 nm thick, even more preferably from 35 to 70 nm thick, even more preferably from 40 to 60 nm thick with an example thickness being from 58 to 63 nm and
   e. the fifth layer (6) is from 10 to 50 nm thick, more preferably from 15 to 45 nm thick, even more preferably from 20 to 40 nm thick, with an example thickness being from 31 to 35 nm.
Item 10. Window according to any one preceding item, wherein, in the first coating, the second layer (3) and, if present, the fourth layer (4) comprises up to 20 at % of aluminium.
Item 11. Window according to any one preceding item wherein at least one of the first coating's first, third, and, if present, fifth layers comprises or consists of two layers of different materials chosen from niobium oxide, titanium oxide, zirconium oxide, a dielectric material chosen among titanium oxide, a mixed oxide of titanium and zirconium, or a mixed nitride of zirconium and silicon.
Item 12. Window according to any one preceding claim wherein the first coating is patterned so that the first coating is not provided continuously across the entire coated substrate.
Item 13. Window according to items 1 to 11 characterized in that, in the first coating, the first layer, the third layer, and, if present, the fifth layer, are identically patterned so that the first layer, the third layer, and the fifth layer are not provided continuously across the entire coated substrate and so that the second layer and the fourth layer, if present, are provided over the entire coated substrate.
Item 14. Window according to item 1 wherein the first layer has a thickness comprised between 3 and 30 nm, the second layer has a thickness comprised between 20 and 90 nm, and the third layer has a thickness comprised between 5 and 50 nm.
Item 15. Window according to item 2, wherein the first layer (2) has a thickness comprised between 3 nm and 20 nm, the second layer (3) has a thickness comprised between 20 nm and 60 nm, the third layer (4) has a thickness comprised between 20 nm and 50 nm, and the fourth layer (5) has a thickness comprised between 3 nm and 110 nm.
Item 16. Window according to any one preceding item, further comprising a third substrate laminated to the first substrate, the third substrate being positioned in between the first substrate and the second substrate.
Item 17. Window according to item 16 wherein the third substrate is laminated to the first substrate using a thermoplastic interlayer, preferably comprising a material chosen among polyvinyl butyral (PVB) or ethyl vinyl acetate (EVA).
Item 18. Window according to any one preceding item, wherein the second substrate supports a functional coating, such as a low emissivity coating or a solar control coating on the surface facing outwards.
Item 19. Window according to any one preceding item, wherein the second substrate supports a functional coating, such as a low emissivity coating advantageously comprising a transparent conductive oxide, on the surface facing inwards
Item 20. Window according to any one preceding item wherein the first substrate is thermally strengthened or tempered.
Item 21. Window according to any one preceding item wherein the first, second and, if present, third substrate consist of soda lime glass.
Item 22. Window according to any one preceding item wherein the first substrate has an ultraviolet light transmittance Tuv, measured according to standard EN410:2011 and without any coating of at least 70%, preferably of at least 80%, more preferably of at least 85%.
Item 23. Window according to any one preceding item wherein the first substrate is a soda lime glass substrate comprising less than 0.04 percent by weight of iron oxide (expressed as Fe2O3), preferably less than 0.02 percent by weight and a redox ratio, measured as the ratio of iron in the ferrous state, expressed as FeO, to the total amount of iron, expressed as Fe2O3, of more than 0.4.
Item 24. Window according to any preceding item wherein the first glass substrate does not comprise a functional coating, for instance a low emissivity insulating coating or a solar control coating, in particular no lowE transparent conductive oxide coating and no metallic coating or layer.
Item 25. Window according to any one preceding item, wherein the UV reflectance is at least 20%, measured on the outwards facing surface of the window.

### EXAMPLES

In the following examples were all layers were deposited using magnetron sputtering on 4 mm thick normal clear soda lime glass. Example 1, 2, and 3 are according to the present invention. Example 4 is a comparative example, similar to Example 2 but with TiOx in stead of TZO. Table 1 below indicates the materials of the different layers and their physical thickness. TZO denotes a mixed oxide of titanium and zirconium mixed oxide which comprises 65% by weight of titanium oxide and 35% by weight of zirconium oxide. TiOx denotes an oxide of titanium with x comprised between 1.8 and 2.2.

TABLE 1

| Example | 1^{st} layer | 2^{nd} layer | 3^{rd} layer | 4^{th} layer | 5^{th} layer |
|---|---|---|---|---|---|
| 1 | TZO | SiO₂ | TZO | | |
| | 12 nm | 40 nm | 36 nm | | |
| 2 | TZO | SiO₂ | TZO | SiO₂ | |
| | 12 nm | 40 nm | 36 nm | 95 nm | |
| 3 | TZO | SiO₂ | TZO | SiO₂ | TZO |
| | 10 nm | 67 nm | 18 nm | 61 m | 34 nm |

Optical properties were determined for double glazing units comprising one example glass sheet and one uncoated 4 mm thick clear soda lime glass sheets separated by a 16 mm wide gap which is filled with an argon/air mixture comprising 90% by volume of argon, with one of the sheets being the respective examples above. Table 2 below shows the optical performances in a double glazing IGU obtained without heat treatment of the substrate bearing the UV reflecting first coating. The UV reflectance in the range from 315 nm to 390 nm is always determined on the uncoated side, which is the side that faces outwards on a building, of the first substrate of the IGU. The first substrate is bearing the UV reflecting first coating on the inwards facing side. The Transmittance Reduction in the range from 315 nm to 390 nm is the transmittance difference between an IGU without any coating and the IGUs made with the respective example coated glass sheets.

TABLE 2

| | | Minimum | | Average |
|---|---|---|---|---|
| | Minimum | Transmittance | Average | Transmittance |
| | Reflectance | Reduction | Reflectance | Reduction |
| | 315 nm to | 315 nm to | 315 nm to | 315 nm to |
| Example | 390 nm | 390 nm | 390 nm | 390 nm |
| 1 (IGU) | 20% | 16% | 32% | 25% |
| 2 (IGU) | 25% | 17% | 40% | 38% |
| 3 (IGU) | 40% | 30% | 62% | 52% |
| 4 (IGU) | 25% | 17% | 40% | 38% |

Examples 1, 2, 3, and 4 were submitted to a heat treatment in a static furnace at 670° C. for a duration of four minutes. Examples 1, 2, and 3 show essentially the same optical properties after this heat treatment as before. In addition on these samples the haze level before heat treatment and after heat treatment was below 0.1%. ΔE* of transmitted and reflected colors, due to the heat treatment were less than 5. On Example 4 the optical properties are modified upon heat treatment and in particular the haze level rises far above the initial 0.1% and is visible by the naked eye.

It should be noted that the minimum reflectance and minimum transmittance reduction in samples 1 and 2 is very similar, despite that example 1 has one layer less and that a notable improvement is obtained when a layer comprising five layers such as in example 3 is used.

The invention is not limited to the substrate being a glazing in a building. For example, the substrate is a door, a balcony, a spandrel.

1. A window for reducing or preventing bird collisions therewith, the window comprising:
a first substrate and a second substrate, spaced apart from one another,
wherein the first substrate is configured to face an exterior of a building,
wherein the first substrate has a first coating on an inward facing surface,
wherein the first coating reflects ultraviolet (UV) radiation,
wherein the first coating comprises first, second, and third layers in this order moving away from the first substrate,
wherein the first and third layers each comprise at least one dielectric material chosen among niobium oxide, titanium oxide, zirconium oxide, a mixed oxide of titanium and zirconium, and a mixed nitride of zirconium and silicon,
wherein the second layer comprises silicon oxide SiOₓ, and
wherein the first coating comprises only the first, second and third layers.

2. The window according to claim 1 wherein, in the first coating,
the first layer is from 3 to 20 nm thick,
the second layer is from 20 to 60 nm thick, and
the third layer is from 20 to 50 nm thick.

3. The window according to claim 1, wherein at least one of the first and third layers comprises or consists of two layers of different materials chosen from niobium oxide, titanium oxide, zirconium oxide, a dielectric material chosen among titanium oxide, a mixed oxide of titanium and zirconium, and a mixed nitride of zirconium and silicon.

4. The window according to claim 1, wherein the first coating is patterned so that the first coating is not provided continuously across the first substrate.

5. The window according to claim 1, wherein in the first coating, the first layer and the third layer are identically patterned so that the first layer and the third layer are not provided continuously across the first substrate and so that the second layer is provided over an entire first substrate.

6. The window according to claim 1, further comprising a third substrate laminated to the first substrate,
wherein the third substrate is positioned in between the first substrate and the second substrate.

7. The window according to claim 1, wherein the second substrate supports a first functional coating on a surface facing outwards and/or a second functional coating on a surface facing inwards.

8. The window according to claim 1, wherein the first substrate is thermally strengthened or tempered.

9. The window according to claim 1, wherein the first substrate has an ultraviolet light transmittance Tuv, measured according to standard EN410:2011 and without any coating of at least 70%.

10. The window according to claim 1, wherein the first substrate is a soda lime glass substrate comprising less than 0.04 percent by weight of iron oxide (Fe₂O₃), and has a redox ratio, measured as a ratio of iron in a ferrous state, expressed as FeO, to a total amount of iron, expressed as Fe₂O₃, of more than 0.4.

11. The window according to claim 1, wherein, in the first coating,
the first layer is from 6 to 16 nm thick,
the second layer is from 30 to 50 nm thick, and
the third layer is from 25 to 45 nm thick.

12. The window according to claim 1, wherein the first substrate without a coating has an ultraviolet light transmittance Tuv, measured according to standard EN410:2011 of at least 80%.

13. The window according to claim 1, wherein the first substrate is a soda lime glass substrate comprising less than 0.02 percent by weight of iron oxide (Fe₂O₃), and has a redox ratio, measured as a ratio of iron in a ferrous state, expressed as FeO, to a total amount of iron, expressed as Fe₂O₃, of more than 0.4.
